(19) United States
(12) Patent Application Publication
(10) Pub. No.: US 2026/0332957 A1
(43) Pub. Date: Oct. 22, 2026

(54) Suspension, Diaphragm, and Acoustic Device Using Same

(71) Applicant: AAC Microtech (Changzhou) Co., Ltd., Changzhou City (CN)

(72) Inventor: Hao Chen, Changzhou (CN)

(21) Appl. No.: 19/317,187

(22) Filed: Sep. 3, 2025

Related U.S. Application Data
(63) Continuation of application No. PCT/CN2025/090251, filed on Apr. 22, 2025.

(51) Int. Cl. H04R 7/18; H04R 7/12; H04R 9/02; H04R 9/06

(52) U.S. Cl. CPC H04R 7/18; H04R 7/127; H04R 9/025; H04R 9/06; H04R 2307/207

(57) ABSTRACT

The present application provides a suspension for an acoustic device having a protruding portion protruding toward one side of the suspension. The protruding portion includes a side close to a center of the suspension and being concave along a direction away from the center of the suspension, and a side away from the center of the suspension protruding along the direction away from the center of the suspension. By virtue of the structure, the suspension reduces the installation impact on the magnetic circuit in the upper and lower spaces, and improves space utilization.

### TECHNICAL FIELD

The present application relates to the field of acoustic devices, particularly to a suspension, a diaphragm, an acoustic device and an application of the acoustic device.

### BACKGROUND

A diaphragm is a membrane for speaker playback. The diaphragm typically comprises a dome located at the center and a suspension disposed surrounding the dome.

In related technology, the suspension of the diaphragm is protruding, and the side arcs on both sides of the suspension protrude in directions away from each other. The KX curve is adjusted by adjusting the curvature of the side arcs on both sides of the suspension and the position of the highest point of the suspension, thereby improving the distortion of the diaphragm. However, the suspension with the above shape can only balance the stress during positive direction vibration, that is, adjust the KX linear term to reduce the second-order distortion, but it is difficult to simultaneously reduce the stress in both positive and negative directions under large amplitude, so it cannot effectively reduce the third-order distortion. Furthermore, when the suspension with the above shape vibrates, the highest point of the suspension moves up and down, limiting the design of the magnetic circuit space above and below.

### SUMMARY

In view of the above problems, the main object of the present application is to provide a suspension, a diaphragm, an acoustic device and an application of the acoustic device, which can achieve the design requirements of reducing diaphragm distortion and improving space utilization.

In a first aspect, the present application provides a suspension, wherein the suspension comprises a protruding portion, the protruding portion protrudes toward one side of the suspension, a side of the protruding portion close to a center of the suspension is concave along a direction away from the center of the suspension, and a side of the protruding portion away from the center of the suspension protrudes along the direction away from the center of the suspension.

Preferably, the protruding portion comprises a first protruding section, a second protruding section and a third protruding section connected sequentially along the direction away from the center of the suspension, the first protruding section is concave along the direction away from the center of the suspension, and the third protruding section protrudes along the direction away from the center of the suspension.

Preferably, the second protruding section protrudes toward a direction away from the suspension.

Preferably, the first protruding section, the second protruding section and the third protruding section are all annular structures.

Preferably, the suspension further comprises a first connecting portion of an annular structure, and the first connecting portion is connected to the side of the protruding portion close to the center of the suspension along a circumferential direction of the protruding portion.

Preferably, the suspension further comprises a second connecting portion of an annular structure, and the second connecting portion is connected to the side of the protruding portion away from the center of the suspension along a circumferential direction of the protruding portion.

In a second aspect, the present application provides a diaphragm, wherein the diaphragm comprises the suspension described above.

Preferably, the diaphragm comprises a dome located at a center, and the suspension is disposed surrounding the dome.

In a third aspect, the present application provides an acoustic device, wherein the acoustic device comprises the diaphragm described above.

The suspension comprises a protruding portion, the protruding portion protrudes toward one side of the suspension, and the structures of both sides of the protruding portion are different, wherein a side of the protruding portion close to the center of the suspension is concave along a direction away from the center of the suspension, and a side of the protruding portion away from the center of the suspension protrudes along the direction away from the center of the suspension. By setting the side of the protruding portion close to the center of the suspension to be concave and setting the side of the protruding portion away from the center of the suspension to be protruding, the equivalent width of the protruding portion of the suspension can be reduced. When the amplitude is large, the protruding portion of the suspension can disperse the z-direction stress to the horizontal direction, thereby reducing the stiffness of the suspension, that is, reducing the stiffness of the diaphragm, increasing the KX quadratic term coefficient, and reducing the third-order distortion of the diaphragm. Furthermore, since the side of the protruding portion close to the center of the suspension is concave and the side of the protruding portion away from the center of the suspension is protruding, when the suspension vibrates, the edge of the side of the protruding portion away from the center of the suspension is fixed, and the edge of the side of the protruding portion close to the center of the suspension moves up and down with the dome of the diaphragm, making the highest point of the protruding portion of the suspension move horizontally, which saves z-direction space of the suspension, reduces the installation impact of the suspension on the magnetic circuit in the upper and lower spaces, and improves space utilization.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a suspension in accordance with an embodiment of the present application;

FIG. 2 is a cross-sectional view of the suspension taken along line A-A in FIG. 1;

FIG. 3 is an enlarged view of portion B shown in FIG. 2;

FIG. 4 is a comparison diagram of total harmonic distortion between the suspension of the present application embodiment and a suspension of a related art;

FIG. 5 is a comparison diagram of KX simulation curves between the suspension of the present application embodiment and the suspension of the prior art;

FIG. 6 is a comparison diagram of KX measurement curves between the suspension of the present application embodiment and the suspension of the prior art;

FIG. 7 is a working state diagram of the suspension according to the present application embodiment (first movement direction);

FIG. 8 is a working state diagram of the suspension according to the present application embodiment (second movement direction).

### DETAILED DESCRIPTION OF THE EMBODIMENTS

To further explain the embodiments, the present application provides drawings. These drawings form part of the disclosure of the present application and are mainly used to explain the embodiments and can be used to explain the operating principles of the embodiments in conjunction with the related descriptions in the specification. With reference to these contents, those skilled in the art should be able to understand other possible implementations and advantages of the present application. The components in the drawings are not drawn to scale, and similar component symbols are generally used to indicate similar components.

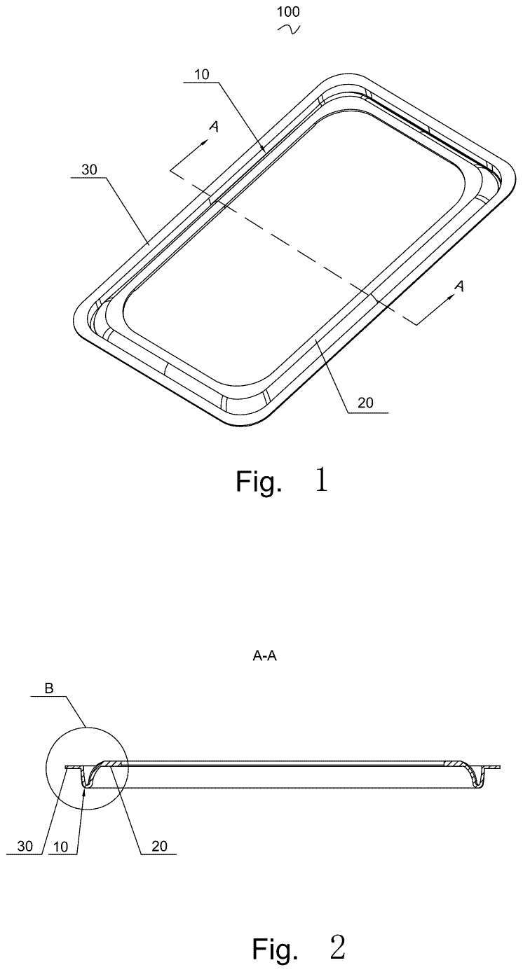

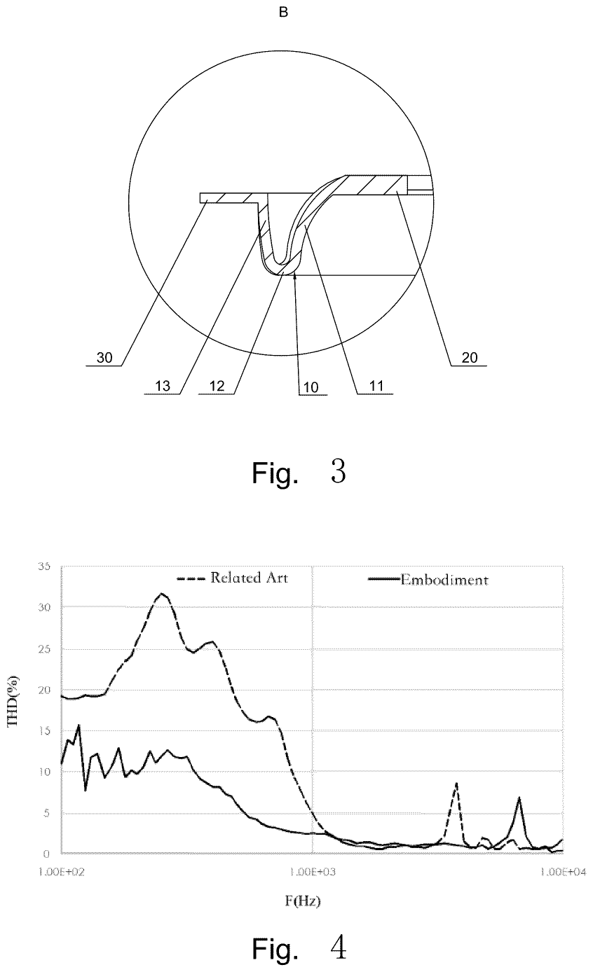

Referring to FIGS. 1 to 3, in a first aspect, the present application provides a suspension 100, which comprises a protruding portion 10. The protruding portion 10 protrudes toward one side of the suspension 100, a side of the protruding portion 10 close to the center of the suspension 100 is concave along a direction away from the center of the suspension 100, and a side of the protruding portion 10 away from the center of the suspension 100 protrudes along the direction away from the center of the suspension 100.

In the suspension 100 of this embodiment of the present application, the suspension 100 comprises a protruding portion 10, the protruding portion 10 protrudes toward one side of the suspension 100, and the structures of both sides of the protruding portion 10 are different, wherein a side of the protruding portion 10 close to the center of the suspension 100 is concave along a direction away from the center of the suspension 100, and a side of the protruding portion 10 away from the center of the suspension 100 protrudes along the direction away from the center of the suspension 100. By setting the side of the protruding portion 10 close to the center of the suspension 100 to be concave and setting the side of the protruding portion 10 away from the center of the suspension 100 to be protruding, the equivalent width of the protruding portion 10 of the suspension 100 can be reduced. When the amplitude is large, the protruding portion 10 of the suspension 100 can disperse the z-direction stress to the horizontal direction, thereby reducing the stiffness of the suspension 100, that is, reducing the stiffness of the diaphragm, increasing the KX quadratic term coefficient, and reducing the third-order distortion of the diaphragm. Furthermore, since the side of the protruding portion 10 close to the center of the suspension 100 is concave and the side of the protruding portion 10 away from the center of the suspension 100 is protruding, when the suspension 100 vibrates, the edge of the side of the protruding portion 10 away from the center of the suspension 100 is fixed, and the edge of the side of the protruding portion 10 close to the center of the suspension 100 moves up and down with the dome of the diaphragm, making the highest point of the protruding portion 10 of the suspension 100 move horizontally, which saves z-direction space of the suspension 100, reduces the installation impact of the suspension 100 on the magnetic circuit in the upper and lower spaces, and improves space utilization.

It should be noted that in this embodiment, the KX curve is a curve showing how the stiffness of the diaphragm changes with position, where K is the stiffness of the suspension of the diaphragm, and X is the displacement of the vibration system.

Preferably, the protruding portion 10 comprises a first protruding section 11, a second protruding section 12 and a third protruding section 13 connected sequentially along the direction away from the center of the suspension 100, the first protruding section 11 is concave along the direction away from the center of the suspension 100, and the third protruding section 13 protrudes along the direction away from the center of the suspension 100. By setting the first protruding section 11 on the side close to the center of the suspension 100 to be concave, and simultaneously setting the third protruding section 13 on the side away from the center of the suspension 100 to be protruding, the equivalent width of the protruding portion 10 can be reduced. When the amplitude is large, the protruding portion 10 can disperse the z-direction stress to the horizontal direction, thereby reducing the stiffness of the suspension 100, that is, reducing the stiffness of the diaphragm, increasing the KX quadratic term coefficient, and reducing the third-order distortion of the diaphragm. Furthermore, the end of the third protruding section 13 away from the second protruding section 12 is indirectly fixed, and the end of the first protruding section 11 away from the second protruding section 12 is indirectly connected to the dome of the diaphragm. When the diaphragm vibrates, the end of the first protruding section 11 away from the second protruding section 12 moves up and down with the dome, and the first protruding section 11 drives the second protruding section 12 to move horizontally, thereby saving z-direction space of the suspension 100 and improving space utilization.

Preferably, the second protruding section 12 protrudes toward a direction away from the suspension 100. The first protruding section 11 and the third protruding section 13 are smoothly connected through the second protruding section 12 that protrudes toward the direction away from the suspension 100, increasing the angle between the first protruding section 11 and the third protruding section 13, improving the relative deformation amount between the first protruding section 11 and the third protruding section 13, and improving the service life of the suspension 100.

Preferably, the first protruding section 11, the second protruding section 12 and the third protruding section 13 are all annular structures, and the annular first protruding section 11, the annular second protruding section 12 and the annular third protruding section 13 are connected sequentially to form an annular protruding portion 10.

Preferably, the suspension 100 comprises a first connecting portion 20 of an annular structure, and the first connecting portion 20 is connected to the side of the protruding portion 10 close to the center of the suspension 100 along a circumferential direction of the protruding portion 10. Specifically, the first connecting portion 20 is connected to the end of the first protruding section 11 away from the second protruding section 12 along the circumferential direction of the protruding portion 10. The first protruding section 11 can be connected to the dome through the first connecting portion 20. When the diaphragm vibrates, the dome drives the end of the first protruding section 11 away from the second protruding section 12 to move up and down through the first connecting portion 20.

Preferably, the suspension 100 further comprises a second connecting portion 30 of an annular structure, and the second connecting portion 30 is connected to the side of the protruding portion 10 away from the center of the suspension 100 along a circumferential direction of the protruding portion 10. Specifically, the second connecting portion 30 is connected to the end of the third protruding section 13 away from the second protruding section 12 along the circumferential direction of the protruding portion 10, and the end of the third protruding section 13 away from the second protruding section 12 is fixed through the second connecting portion 30.

Referring to FIG. 4, FIG. 4 is a comparison diagram of KX simulation curves between the suspension of the present application embodiment and the suspension of the prior art, where the horizontal coordinate represents displacement x (mm), the vertical coordinate represents k, the dash-dot line represents the KX simulation curve of the suspension of the prior art, and the solid line represents the KX simulation curve of the suspension of the present application embodiment.

Wherein, the KX simulation curve of the suspension of the present application embodiment is: y=−3.020x⁶−0.735x⁵+3.234x⁴+0.197x³−1.507x²−0.444x+3.450; the KX simulation curve of the suspension of the prior art is: y=2.636x⁶−0.677x⁵+0.256x⁴−0.050x³−0.045x²−1.205x+3.395. From these two formulas, it can be seen that the linear term coefficient of the KX simulation curve of the suspension of the present application embodiment is −0.4444, the quadratic term coefficient is −1.5072, while the linear term coefficient of the KX simulation curve of the prior art suspension is −1.2053, and the quadratic term coefficient is −0.0459. The absolute value of the linear term coefficient −0.4444 of the KX simulation curve of the suspension of the present application embodiment is smaller than the absolute value of the linear term coefficient −1.2053 of the KX simulation curve of the prior art suspension. Compared with the prior art, the linear term coefficient of the KX simulation curve of the suspension of this embodiment is reduced, thereby improving the second-order distortion of the suspension. The absolute value of the quadratic term coefficient −1.5072 of the KX simulation curve of the suspension of the present application embodiment is greater than the absolute value of the quadratic term coefficient −0.0459 of the KX simulation curve of the prior art suspension. Compared with the prior art, the quadratic term coefficient of the KX simulation curve of the suspension of this embodiment is increased, thereby improving the third-order distortion of the suspension.

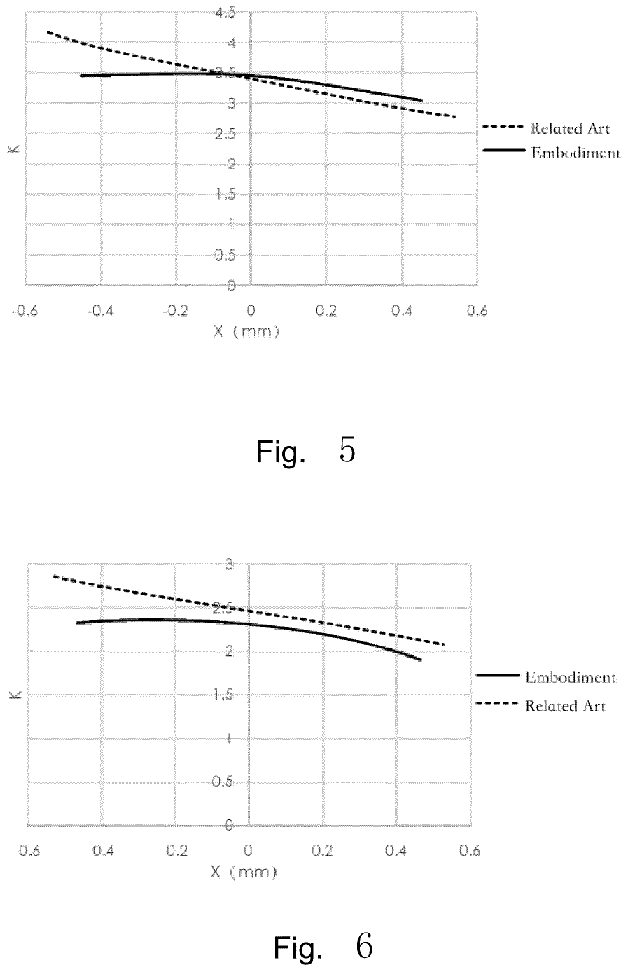

Referring to FIG. 5, FIG. 5 is a comparison diagram of KX measurement curves between the suspension of the present application embodiment and the suspension of the prior art, where the horizontal coordinate represents displacement x (mm), the vertical coordinate represents k, the dash-dot line represents the KX measurement curve of the suspension of the prior art, and the solid line represents the KX measurement curve of the suspension of the present application embodiment.

Wherein, the KX measurement curve of the suspension of the present application embodiment is: y=−1E-08x⁶+3E-09x⁵−0.582x⁴−0.322x³−0.763x²−0.375x+2.300; the KX measurement curve of the suspension of the prior art is: y=−3E-11x⁶+1E-09x⁵+0.185x⁴−0.254x³−0.035x²−0.674x+2.457. From these two formulas, it can be seen that the linear term coefficient of the KX measurement curve of the suspension of the present application embodiment is −0.375, the quadratic term coefficient is −0.763, while the linear term coefficient of the KX measurement curve of the prior art suspension is −0.674, and the quadratic term coefficient is −0.035. The absolute value of the linear term coefficient −0.375 of the KX measurement curve of the suspension of the present application embodiment is smaller than the absolute value of the linear term coefficient −0.674 of the KX measurement curve of the prior art suspension. Compared with the prior art, the linear term coefficient of the KX measurement curve of the suspension of this embodiment is reduced, thereby improving the second-order distortion of the suspension. The absolute value of the quadratic term coefficient −0.763 of the KX measurement curve of the suspension of the present application embodiment is greater than the absolute value of the quadratic term coefficient −0.035 of the KX measurement curve of the prior art suspension. Compared with the prior art, the quadratic term coefficient of the KX measurement curve of the suspension of this embodiment is increased, thereby improving the third-order distortion of the suspension.

From FIGS. 4 and 5, it can be seen that the comparison of KX simulation curves matches with the comparison of KX measurement curves. Compared with the prior art suspension, both the second-order distortion and third-order distortion of the suspension of the present application embodiment are significantly reduced.

Referring to FIG. 6, FIG. 6 is a comparison diagram of total harmonic distortion between the suspension of the present application embodiment and the suspension of the prior art, where the horizontal coordinate represents frequency f (Hz), the vertical coordinate represents total harmonic distortion THD (%), the dash-dot lines represent the total harmonic distortion curves of two prior art suspensions, and the solid lines represent the total harmonic distortion curves of two suspensions of the present application embodiment.

From FIG. 6, it can be seen that the total harmonic distortion curves of the suspensions of embodiment 1 and embodiment 2 of the present application are generally below the total harmonic distortion curves of prior art suspensions 1 and 2, indicating that the distortion of the prior art suspensions is more severe than that of the suspensions of the present application embodiment, and the distortion of the suspensions of the present application embodiment is significantly improved. Under the condition of improved voice coil cooperation, the distortion of the suspension of the present application embodiment is reduced from 35% to 15%, showing a significant effect.

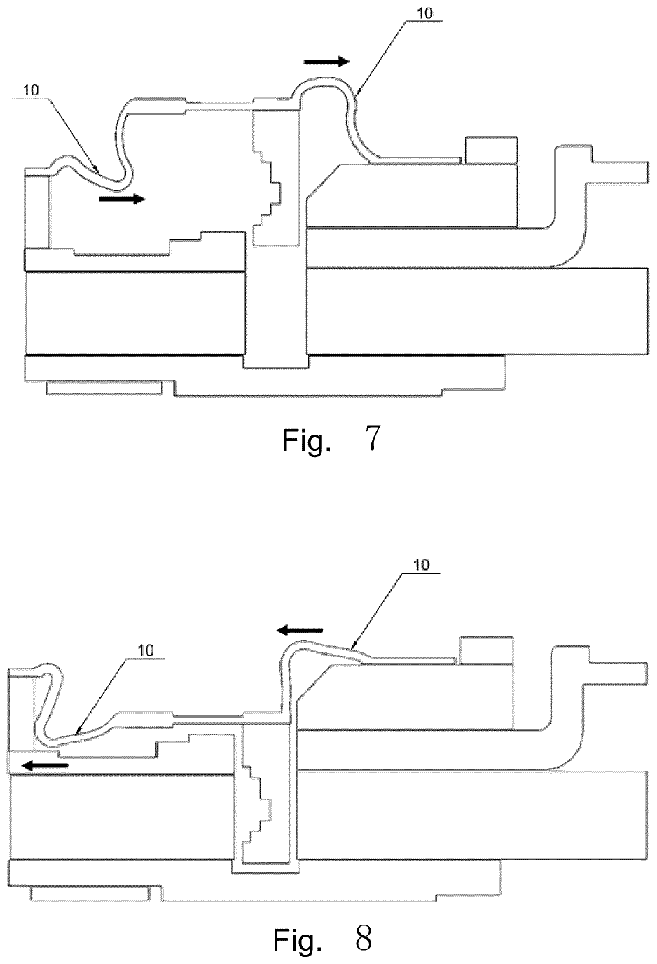

Referring to FIGS. 7 and 8, FIG. 7 is a working state diagram of the suspension of the present application embodiment in a first movement direction, and FIG. 8 is a working state diagram of the suspension of the present application embodiment in a second movement direction. From FIGS. 7 and 8, it can be seen that during the up and down vibration of the side close to the center of the suspension, the peak point of the protruding portion of the suspension moves horizontally. That is, under large amplitude, the highest point of the suspension of the present application embodiment moves horizontally, significantly saving the space below the suspension, namely saving the z-direction space of the suspension, which is beneficial for space design optimization.

In a second aspect, the present application provides a diaphragm (not shown in the Figs.), wherein the diaphragm comprises the suspension 100 described above.

Preferably, the diaphragm comprises a dome (not shown in the Figs.) located at the center, and the suspension 100 is disposed surrounding the dome.

Specifically, the first connecting portion 20 of the suspension 100 is connected to the outer edge of the dome along the circumferential direction of the dome, thereby achieving the connection between the suspension 100 and the dome.

In a third aspect, the present application provides an acoustic device, wherein the acoustic device comprises the diaphragm described above. The acoustic device in this embodiment can be a speaker.

In a fourth aspect, the present application provides an application of the acoustic device described above in a terminal product. The acoustic device in this embodiment can be applied in fields such as mobile phones, headphones, tablets, computers, automobiles, televisions, audio systems, etc.

The foregoing is merely illustrative of embodiments of the present invention, and it should be noted that modifications may be made to those skilled in the art without departing from the spirit of the invention but are intended to be within the scope of the invention.

What is claimed is:

1. A suspension for an acoustic device, comprising:
a protruding portion protruding toward one side of the suspension, including a side close to a center of the suspension and being concave along a direction away from the center of the suspension, and a side away from the center of the suspension protruding along the direction away from the center of the suspension.

2. The suspension as described in claim 1, wherein the protruding portion comprises a first protruding section, a second protruding section and a third protruding section connected sequentially along the direction away from the center of the suspension, the first protruding section is concave along the direction away from the center of the suspension, and the third protruding section protrudes along the direction away from the center of the suspension.

3. The suspension as described in claim 2, wherein the second protruding section protrudes toward a direction away from the suspension.

4. The suspension as described in claim 2, wherein the first protruding section, the second protruding section and the third protruding section are all annular structures.

5. The suspension as described in claim 1, wherein the suspension further comprises a first connecting portion of an annular structure, and the first connecting portion is connected to the side of the protruding portion close to the center of the suspension along a circumferential direction of the protruding portion.

6. The suspension as described in claim 1, wherein the suspension further comprises a second connecting portion of an annular structure, and the second connecting portion is connected to the side of the protruding portion away from the center of the suspension along a circumferential direction of the protruding portion.

7. A diaphragm including a suspension as described in claim 1.

8. The diaphragm as described in claim 7, wherein the diaphragm comprises a dome located at a center, and the suspension is disposed surrounding the dome.

9. An acoustic device including a diaphragm as described in claim 8.
